(19) United States
(12) Patent Application Publication
(10) Pub. No.: US 2026/0234007 A1
(43) Pub. Date: Aug. 13, 2026

(54) PROCESS FOR MANUFACTURING OXIDES

(71) Applicant: Evonik Operations GmbH, Essen (DE)

(72) Inventors: Franz Schmidt, Gross-Gerau (DE); Alexander Lygin, Griesheim (DE)

(73) Assignee: Evonik Operations GmbH, Essen (DE)

(21) Appl. No.: 19/153,873

(22) PCT Filed: Jan. 31, 2024
(86) PCT No.: PCT/EP2024/052294

§ 371 Date: Aug. 5, 2025

(30) Foreign Application Priority Data
Feb. 10, 2023 (EP) 23156041.8

(51) Int. Cl. C01B 33/18; C01F 7/306; C01G 23/07

(52) U.S. Cl. CPC C01B 33/183; C01F 7/306; C01G 23/07

(57) ABSTRACT

The present invention relates to a pyrogenic process for manufacturing metal oxides or metalloid oxides wherein a metal precursor and/or a metalloid precursor is introduced into a flame formed by burning a gas mixture comprising oxygen and hydrogen, wherein at least a part of the hydrogen and at least a part of the oxygen have been obtained from electrolysis of water or an aqueous solution, using electrical energy, at least a part of which has been obtained from a renewable energy source, and wherein water (H₂O) is introduced into the flame, and wherein the total molar ratio TRON of oxygen gas to nitrogen gas TRON=n(O₂):n(N₂) of all streams introduced into the flame prior to ignition combined is TRON≥0.25 and ≤1.

Finely dispersed metal oxide and metalloid oxide powders, such as silica, alumina, titania and others are required for a broad range of technical applications today. Well-established routes for their production are based on pyrogenic processes, i.e. processes involving flame hydrolysis and/or flame pyrolysis of precursors (cf. Ullmann's Encyclopedia of Industrial Chemistry (1982) Volume 21, page 464). The flame used in these processes is typically formed by combining and igniting streams of a gas mixture comprising hydrogen and a gas mixture comprising oxygen in a burner. Volatile metal or metalloid precursors are supplied into the hydrogen or oxygen stream or into the flame directly and converted therein to finely dispersed metal oxide and/or metalloid oxide powders.

U.S. Pat. No. 6,248,495 discloses a process for manufacturing metal oxide by introducing a metal precursor into a flame, wherein the flame used is formed by burning a gas mixture comprising oxygen and hydrogen.

The oxygen used for pyrogenic processes may originate from air or can be obtained by energy-consuming fractional distillation of air. In the first case (air use), large amounts of nitrogen are introduced into the system, thus significantly increasing the overall gas volume, and thus reducing productivity of the plant.

Moreover, due to dilution with nitrogen when using air as an oxygen-source, the temperature of the flame (usually calculated as adiabatic flame temperature) is limited to about 1600-2000° C. Therefore, in view of the fact that some products of pyrogenic processes require higher adiabatic flame temperatures, use of oxygen-enriched mixtures is required in these cases instead (cf. e.g. WO2004054929A1).

However, temperature gradients in the flame may be more significant in processes using oxygen-enriched mixtures than when using unmodified air, and such temperature gradients may result in less homogeneous products.

In view of the above, a problem to be solved by the present invention resides in providing a process for producing pyrogenic metal oxides of well-established, homogeneous quality, with reduced overall CO₂ emissions and minimal external fossil-based energy consumption, while providing higher productivity (i.e. higher metal or metalloid oxide content per unit of gas volume in the product mixture).

The present invention relates to a pyrogenic process for manufacturing metal oxides or metalloid oxides that solves these problems, wherein a metal precursor and/or a metalloid precursor is introduced into a flame formed by burning a gas mixture comprising oxygen, hydrogen and nitrogen, wherein at least a part of the hydrogen and at least a part of the oxygen have been obtained from electrolysis of water or an aqueous solution, using electrical energy, at least a part of which has been obtained from a renewable energy source; and wherein water (H₂O) is introduced into the flame; and wherein the total molar ratio TRON of oxygen gas to nitrogen gas TRON=n(O₂):n(N₂) of all streams introduced into the flame prior to ignition combined is TRON≥0.25 and ≤1.

Hydrogen and/or oxygen prepared via water electrolysis typically contain significant amount of water. Drying these gases after the electrolysis is an additional process step, increasing the cost and the CO₂ footprint of the total process. It has now been found, that water present in the hydrogen and/or oxygen obtained by the water electrolysis may be at least partially directly used in the production of fumed metal oxides according to the invention thus making it unnecessary to introduce additional water. Particularly preferably, all the water present in the oxygen and/or hydrogen obtained in the water electrolysis is used in the pyrogenic process. Surprisingly, this inventive process not only provides finely dispersed metal oxide and metalloid oxide powders in high quality, but also helps significantly reducing overall CO₂-emissions for hydrogen generation and oxygen generation, as well as increasing productivity of the plant.

Moreover, the presence of water in the feed gas, e.g. in the oxygen stream, is believed to improve the thermal conductivity of the feed gas, thus improving thermal equilibration in feed gas and the product gas mixture, and thereby reducing the overall temperature as well as temperature gradients in the flame and thus enabling access to lower adiabatic flame temperatures as well as more homogeneous products.

### THE PRESENT INVENTION

The problems discussed above are solved by the present invention providing a process for manufacturing metal oxides and/or metalloid oxides, comprising step (X):
(X) introducing a metal precursor and/or a metalloid precursor into a flame,
   wherein
      (a) the flame used in step (X) is formed by burning a gas mixture comprising oxygen, hydrogen and nitrogen,
         wherein at least a part of the hydrogen and at least a part of the oxygen have been obtained from electrolysis of water or an aqueous solution, using electrical energy, at least a part of which
      has been obtained from a renewable energy source;
      and wherein
      (b) water (H₂O) is introduced into the flame;
      and wherein
      (c) the total molar ratio TRON of oxygen gas to nitrogen gas TRON=n(O₂):n(N₂) of all streams introduced into the flame prior to ignition combined is TRON≥0.25 and ≤1.

Forming a flame by burning a gas mixture comprising oxygen, hydrogen and nitrogen and introducing a metal precursor and/or a metalloid precursor therein, according to the present invention can be achieved by any means known to people of skill in the art. Comprehensive descriptions of such pyrogenic processes particularly suitable for the purpose of the present invention have been described in the art, cf. e.g. Ullmann's Encyclopedia of Industrial Chemistry (1982) Volume 21, page 464. In the context of the present invention it is important to point out, that, in addition to gas streams introduced into the flame prior to ignition, a number of pyrogenic processes apply a second type of gas stream—gas streams introduced into the flame past ignition. Streams that are introduced into the flame prior to ignition enter the flame at its most upstream region, thus participating in and/or interacting with the combustion reaction in a very comprehensive manner over the entire length of the flame. Streams that are introduced into the flame past ignition on the other hand, do not pass through the most upstream region of the flame and thus do not participate in and/or interact with the combustion reaction as comprehensively as the streams added prior to ignition. Streams introduced past ignition are typically added for stabilizing the flame and preventing deposits in the reaction apparatus.

In preferred embodiments of the present invention the renewable energy source is selected from the group consisting of solar energy, wind energy, geothermal energy, hydropower from flowing water, tidal energy, energy obtained from burning of biomass, waste or biofuel, and combinations of these energy sources.

According to the present invention at least a part of the hydrogen and at least a part of the oxygen used for forming the flame are obtained from electrolysis of water or an aqueous solution, using electrical energy, at least a part of which has been obtained from a renewable energy source. A wide spectrum of processes for the production of hydrogen and/or oxygen from electrolysis of water or aqueous solutions are available in the art, all of which can be used in the context of the present invention.

In a preferred embodiment of the present invention the oxygen used for forming the flame, which is obtained from electrolysis of water or an aqueous solution, comprises at least 0.1 wt. % water.

In a particularly preferred embodiment of the present invention the oxygen used for forming the flame, which is obtained from electrolysis of water or an aqueous solution comprises at least 0.5 wt. % water, preferably at least 1 wt. %.

In preferred embodiments of the present invention the total molar ratio TRON of oxygen gas to nitrogen gas TRON=n(O₂):n(N₂) of all streams introduced into the flame prior to ignition combined is at least 0.26, more preferably at least 0.270, most preferably at least 0.275 and lower or equal to 1, preferably lower or equal to 0.8 and more preferably lower or equal to 0.6. The inventive range for TRON is crucial for the present invention, since If TRON values are too high (i.e. O₂-rich mixtures, not enough N₂), the safety risk in process control is increased (pure O₂ compared to air) and process costs are significantly higher (because more pure O₂ is required).

In preferred embodiments of the present invention the metal oxides or metalloid oxides are selected from the oxides of aluminum (Al), titanium (Ti), zirconium (Zr), yttrium (Y), lithium (Li), magnesium (Mg), lanthanum (La), cerium (Ce), iron (Fe), zinc (Zn), and silicon (Si).

In preferred embodiments of the present invention the metal oxides or metalloid oxides are selected from the oxides of aluminum (Al), titanium (Ti), and silicon (Si).

According to the present invention the metal precursor or metalloid precursor is a compound containing one or more metals or metalloids, which compound undergoes chemical transformation, when exposed to a flame formed by burning a gas mixture comprising oxygen and hydrogen, into a mixture of one or more solid (at 25° C. and atmospheric pressure) oxides of a metal or metalloid and compounds that are gaseous or volatile at 25° C. and atmospheric pressure.

In preferred embodiments of the present invention the metal precursor or metalloid precursor is selected from aluminum chloride, aluminum oxychloride, titanium tetrachloride, titanium trichloride, titanium oxychloride, tetraalkoxytitanate, tetraalkoxysilicate, cyclic or acyclic siloxane, silicon tetrachloride, trichlorosilane, methyltrichlorosilane, dichlorosilane, monochlorosilane or mixtures thereof.

In a preferred embodiment of the present invention the total molar ratio TRWM of water to metal precursor and/or metalloid precursor introduced into the flame TRWM=n(H₂O):n(metal precursor and/or metalloid precursor combined) is TRWM≥0.005.

In a particularly preferred embodiment of the present invention the total molar ratio TRWM of water to metal precursor and/or metalloid precursor introduced into the flame TRWM=n(H₂O):n(metal precursor and/or metalloid precursor) is TRWM≥0.01.

In a particularly preferred embodiment of the present invention the total molar ratio TRWM of water to metal precursor and/or metalloid precursor introduced into the flame TRWM=n(H₂O):n(metal precursor and/or metalloid precursor combined) is TRWM≥0.005, and the total molar ratio TRON of oxygen gas to nitrogen gas TRON=n(O₂):n(N₂) of all streams introduced into the flame prior to ignition combined is TRON≥0.26 and ≤1.

In the context of the present invention standard conditions are defined as temperature of 273, 15 K=0° C. and pressure of 100 000 Pa=1,000 bar.

Adiabatic Flame temperatures are calculated with commercially available software tools using initial temperatures, reaction enthalpies and heat capacities of all components present in the flame zone.

Throughout this specification the terms “gamma” or “gamma ratio”, as well as “lambda” or “lambda ratio” are defined as follows:

$$“ gamma ” or “ gamma ratio ” = {H}_{2} supplied / stoichiometrically required {H}_{2}$$

$$“ lambda ” or “ lambda ratio ” = {O}_{2} supplied / stoichiometrically required {O}_{2}$$

### EXAMPLES

### Comparative Example 1

The mixture of 2.7 kg/h SiCl₄ in vapor form, 1.0 m³/h hydrogen, 0.2 m³/h nitrogen and 2.4 m³/h air was premixed in a burner as known from prior art. These gases are referred as core gases, mainly contributing to the product properties and are listed in table 1. The burner flame was stabilized by 0.5 m³/h hydrogen which is uses as a mantel flame. Additional to that 6 m³/h secondary air shields the flame from the combustion chamber. The reaction mixture was ignited and burned from the opening of the burner into the combustion chamber and further into the cooled flame tube. The particle gas mixture was further cooled down and the fumed silica powder formed was separated from the gases and deacidified. The adiabatic flame temperature, calculated from the core gases and the particle properties are shown in table 2.

### Comparative Example 2

The mixture of 2.7 kg/h SiCl₄ in vapor form, 1.0 m³/h hydrogen, 0.2 m³/h nitrogen and 1.4 m³/h air, 0.2 m³/h oxygen (obtained not from water electrolysis) was premixed in a burner as known from prior art. These gases are referred as core gases, mainly contributing to the product properties and are listed in table 1. The burner flame was stabilized by 0.5 m³/h hydrogen which is uses as a mantel flame. Additional to that 6 m³/h secondary air shields the flame from the combustion chamber. The reaction mixture was ignited and burned from the opening of the burner into the combustion chamber and further into the cooled flame tube. The particle gas mixture was further cooled down and the fumed silica powder formed was separated from the gases and deacidified. The adiabatic flame temperature, calculated from the core gases and the particle properties are shown in table 2.

### Example 2

The mixture of 2.7 kg/h SiCl₄ in vapor form, 1.0 m³/h hydrogen obtained from water electrolysis, 0.2 m³/h nitrogen, 1.4 m³/h air and 0.2 m³/h oxygen obtained from water electrolysis containing water vapor corresponding to 0.003 kg/h vaporized water was premixed in a burner as known from prior art. These gases are referred as core gases, mainly contributing to the product properties and are listed in table 1. The burner flame was stabilized by 0.5 m³/h hydrogen which is uses as a mantel flame. Additional to that 6 m³/h secondary air shields the flame from the combustion chamber. The reaction mixture was ignited and burned from the opening of the burner into the combustion chamber and further into the cooled flame tube. The particle gas mixture was further cooled down and the fumed silica powder formed was separated from the gases and deacidified. The adiabatic flame temperature, calculated from the core gases and the particle properties are shown in table 2.

### Example 3

The mixture of 2.7 kg/h SiCl₄ in vapor form, 1.0 m³/h hydrogen obtained from water electrolysis, 0.2 m³/h nitrogen, 1.0 m³/h air and 0.3 m³/h oxygen obtained from water electrolysis containing water vapor corresponding to 0.003 kg/h vaporized water was premixed in a burner as known from prior art. These gases are referred as core gases, mainly contributing to the product properties and are listed in table 1. The burner flame was stabilized by 0.5 m³/h hydrogen which is uses as a mantel flame. Additional to that 6 m³/h secondary air shields the flame from the combustion chamber. The reaction mixture was ignited and burned from the opening of the burner into the combustion chamber and further into the cooled flame tube. The particle gas mixture was further cooled down and the fumed silica powder formed was separated from the gases and deacidified. The adiabatic flame temperature, calculated from the core gases and the particle properties are shown in table 2.

### Example 4

The mixture of 2.7 kg/h SiCl₄ in vapor form, 1.0 m³/h hydrogen obtained from water electrolysis, 0.2 m³/h nitrogen, 1.0 m³/h air and 0.3 m³/h oxygen obtained from water electrolysis containing water vapor and additional 0.2 kg/h vaporized water was premixed in a burner as known from prior art. These gases are referred as core gases, mainly contributing to the product properties and are listed in table 1. The burner flame was stabilized by 0.5 m³/h hydrogen which is uses as a mantel flame. Additional to that 6 m³/h secondary air shields the flame from the combustion chamber. The reaction mixture was ignited and burned from the opening of the burner into the combustion chamber and further into the cooled flame tube. The particle gas mixture was further cooled down and the fumed silica powder formed was separated from the gases and deacidified. The adiabatic flame temperature, calculated from the core gases and the particle properties are shown in table 2.

TABLE 1
Process parameters

| | | Primary | | | TRON | Core | | TRWM | | |
|---|---|---|---|---|---|---|---|---|---|---|
| | SiCl₄ | air | O₂ | N₂ | O₂/N₂ | H₂ | H₂O | H₂0/Si | gamma | lambda |
| Example | [kg/h] | [m³/h] | [m³/h] | [m³/h] | [mol/mol] | [m³/h] | [kg/h] | [mol/mol] | (core) | (core) |
| Comp. 1 | 2.7 | 2.4 | 0.0 | 0.2 | 0.240 | 1 | 0.0 | 0 | 1.4 | 1.0 |
| Comp. 2 | 2.7 | 1.4 | 0.2 | 0.2 | 0.378 | 1 | 0.0 | 0 | 1.4 | 1.0 |
| Ex 2 | 2.7 | 1.4 | 0.2 | 0.2 | 0.378 | 1 | 0.003 | 0.011 | 1.4 | 1.0 |
| Ex 3 | 2.7 | 1.0 | 0.3 | 0.2 | 0.515 | 1 | 0.003 | 0.011 | 1.4 | 1.0 |
| Ex 4 | 2.7 | 1.0 | 0.3 | 0.2 | 0.515 | 1 | 0.2 | 0.7 | 1.4 | 1.0 |

TABLE 2
Plant productivity, flame temperature and product properties

| | SiCL₄ | Adiab. | SiO₂ | Tamped |
|---|---|---|---|---|
| | concentration in | Flame temp. | BET | density |
| Example | feed [kg/m³] | [° C.] | [m²/g] | [g/L] |
| Comp. 1 | 0.683 | 2026 | 376 | 24 |
| Comp. 2 | 0.854 | 2431 | 157 | 33 |
| Ex 2 | 0.855 | 2428 | 164 | 35 |
| Ex 3 | 0.944 | 2627 | 121 | 46 |
| Ex 4 | 0.870 | 2421 | 199 | 35 |

The examples show that both electrolytically produced H₂ and O₂ can be used in the same pyrogenic process, wherein reducing the overall CO₂ emissions of the overall process (including H₂ and O₂ production). Simultaneously, productivity of the plant can be increased by using less N₂ ballast gas (Ex 2,3) and water present in the feed (Ex 4). Furthermore, as evidenced by example 2 in comparison with comparative example 2, products with higher specific surface area can be obtained by using undried oxygen from electrolysis, additionally thus, obviating the need for water removal.

Without wishing to be bound by any theory, small amounts of water present in the feed (Ex 2, 3) are believed to improve the thermal conductivity of the process product gas mixture and make the temperature in the flame more homogeneous, while larger water amount (Ex 4) is shown to significantly reduce the flame temperature thus delivering a product with the desired BET and lower process gas volume (=higher productivity of the plant).

1. A process for manufacturing a metal oxide and/or a metalloid oxide, comprising (X):
(X) introducing a metal precursor and/or a metalloid precursor into a flame, wherein
(a) the flame used in (X) is formed by burning a gas mixture comprising oxygen, hydrogen, and nitrogen,
wherein at least a part of the hydrogen and at least a part of the oxygen have been obtained from electrolysis of water or an aqueous solution, using electrical energy, at least a part of which has been obtained from a renewable energy source;
and wherein
(b) water (H₂O) is introduced into the flame;
and wherein
(c) a total molar ratio TRON of oxygen gas to nitrogen gas TRON=n(O₂):n(N₂) of all streams introduced into the flame prior to a combined ignition is TRON≥0.25 and ≤1.

2. The process according to claim 1, wherein the oxygen obtained from electrolysis of water or an aqueous solution comprises at least 0.1 wt. % water.

3. The process according to claim 1, wherein the oxygen obtained from electrolysis of water or an aqueous solution comprises at least 0.5 wt. % water.

4. The process according to claim 1, wherein a total molar ratio TRWM of water to the metal precursor and/or the metalloid precursor introduced into the flame TRWM=n(H₂O):n(metal precursor and/or metalloid precursor combined) is TRWM≥0.005.

5. The process according to claim 4, wherein the total molar ratio TRWM of water to the metal precursor and/or the metalloid precursor introduced into the flame TRWM=n(H₂O):n(metal precursor and/or metalloid precursor) is TRWM≥0.01.

6. The process according to claim 1, wherein the renewable energy source is selected from the group consisting of solar energy, wind energy, geothermal energy, hydropower from flowing water, tidal energy, energy obtained from burning of biomass, waste or biofuel, and combinations of these energy sources.

7. The process according to claim 1, wherein the metal oxide or the metalloid oxide is selected from an oxide of aluminum, titanium, zirconium, yttrium, lithium, magnesium, lanthanum, cerium, iron, zinc, and silicon.

8. The process according to claim 1, wherein the metal oxide or the metalloid oxide is selected from an oxide of aluminum, titanium, and silicon.

9. The process according to claim 1, wherein the metal precursor or the metalloid precursor is selected from the group consisting of aluminum chloride, aluminum oxychloride, titanium tetrachloride, titanium trichloride, titanium oxychloride, tetraalkoxytitanate, tetraalkoxysilicate, cyclic or acyclic siloxane, silicon tetrachloride, trichlorosilane, methyltrichlorosilane, dichlorosilane, and monochlorosilane or a mixture thereof.

10. The process according to claim 1, wherein the total molar ratio TRON of oxygen gas to nitrogen gas TRON=n(O₂):n(N₂) of all streams introduced into the flame prior to the combined ignition is at least 0.26 and lower or equal to 1.

11. The process according to claim 4, wherein
the total molar ratio TRWM of water to the metal precursor and/or the metalloid precursor introduced into the flame TRWM=n(H₂O):n(metal precursor and/or metalloid precursor combined) is TRWM≥0.005, and wherein
the total molar ratio TRON of oxygen gas to nitrogen gas TRON=n(O₂):n(N₂) of all streams introduced into the flame prior to the combined ignition is TRON≥0.25 and ≤1.

12. The process according to claim 3, wherein the oxygen obtained from electrolysis of water or the aqueous solution comprises at least 1 wt. % water.

13. The process according to claim 10, wherein the total molar ratio TRON of oxygen gas to nitrogen gas TRON=n(O₂):n(N₂) of all streams introduced into the flame prior to the combined ignition is at least 0.26 and lower or equal to 0.8.

14. The process according to claim 13, wherein the total molar ratio TRON of oxygen gas to nitrogen gas TRON=n(O₂):n(N₂) of all streams introduced into the flame prior to the combined ignition is at least 0.26 and lower or equal to 0.6.

15. The process according to claim 10, wherein the total molar ratio TRON of oxygen gas to nitrogen gas TRON=n(O₂):n(N₂) of all streams introduced into the flame prior to the combined ignition is at least 0.270 and lower or equal to 1.

16. The process according to claim 15, wherein the total molar ratio TRON of oxygen gas to nitrogen gas TRON=n(O₂):n(N₂) of all streams introduced into the flame prior to the combined ignition is at least 0.270 and lower or equal to 0.8.

17. The process according to claim 16, wherein the total molar ratio TRON of oxygen gas to nitrogen gas TRON=n(O₂):n(N₂) of all streams introduced into the flame prior to the combined ignition is at least 0.270 and lower or equal to 0.6.

18. The process according to claim 10, wherein the total molar ratio TRON of oxygen gas to nitrogen gas TRON=n(O₂):n(N₂) of all streams introduced into the flame prior to the combined ignition is at least 0.275 and lower or equal to 1.

19. The process according to claim 18, wherein the total molar ratio TRON of oxygen gas to nitrogen gas TRON=n(O₂):n(N₂) of all streams introduced into the flame prior to the combined ignition is at least 0.275 and lower or equal to 0.8.

20. The process according to claim 19, wherein the total molar ratio TRON of oxygen gas to nitrogen gas TRON=n(O₂):n(N₂) of all streams introduced into the flame prior to the combined ignition is at least 0.275 and lower or equal to 0.6.
